(19) United States
(12) Patent Application Publication
(10) Pub. No.: US 2005/0200627 A1
(43) Pub. Date: Sep. 15, 2005

(54) Techniques for graphics profiling

(75) Inventor: Chuck V. Desylva, Fair Oaks, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/797,957

(22) Filed: Mar. 11, 2004

(51) Int. Cl. G06F 13/14; G09G 5/02; G09G 5/00

(52) U.S. Cl. 345/520; 345/522; 345/699; 345/204; 345/214

(57) ABSTRACT

Methods, systems, and apparatus profile the processing of a graphics application. Performance data of a processing graphics application is monitored and dynamically presented on a display of a viewer at defined intervals. The performance data includes hardware and driver performance data for the processing graphics application at the defined intervals. The viewer can inspect the performance data for purposes of customizing the graphics application for a targeted hardware and software platform.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the sample screen snapshots and data as described below and in any drawings hereto: Copyright © 2004, Intel Corporation, All Rights Reserved.

### TECHNICAL FIELD

Embodiments of the present invention relate generally to graphics processing, and more particularly to techniques for profiling graphics applications.

### BACKGROUND INFORMATION

Graphics rendering is hardware and software intensive. The hardware is generally associated with graphic processors and memory buffers that actively translate graphics data from native formats to formats which are presented on a display for viewing. The software is typically associated with graphics drivers that manipulate the hardware during the rendering. Any particular graphics application, designed to produce custom graphics, interfaces with the graphics drivers and hardware in order to produce desired effects on a display for a viewer.

3D graphics rendering is particularly problematic (e.g., processor and memory intensive) because there are a number of characteristics associated with 3D objects which adds to the processing complexity and memory requirements associated with rendering. For example, 3D objects include depth perception characteristics which define how portions of the 3D objects are rendered in order to produce a proper depth perception for a viewer.

Traditionally, developers have used performance tools to debug and optimize their graphics applications. These conventional tools may isolate global areas within their code that is problematic and which can be improved, but these tools are not useful for optimizing code for specific targeted platforms. That is, conventional tools can assist developers in optimizing their code in a platform-generic or platform-independent manner, but conventional tools do not assist in helping developers who desire to optimize their code for a specific desired platform, which has a specific processor, memory, and graphics driver architecture.

The lack of ability to optimize graphics applications for specific platforms means that vendors are forced to limit the release of their graphics applications to specific hardware configurations having certain minimal processor and memory capabilities. Consequently, a vendor's product is limited to a smaller market than the vendor would like. Furthermore, many consumers who might otherwise buy a vendor's graphic application, become frustrated because they want the vendor's product, but they do not want to upgrade their platforms in order to use the product. In essence, the consumers view a hardware upgrade as part of the price needed for acquiring the product, and that upgrade expense puts the product out of reach (from a financial standpoint) for many otherwise willing buyers of the product.

Therefore, there is a need for improved profiling of graphics applications, the improved profiling should permit the code of graphics application to be analyzed based on its performance on a specific platforms.

### BRIEF DESCRIPTION OF THE DRAWINGS

FIG. 1 is a flowchart of a method for profiling a graphics application.

FIG. 2 is a flowchart of another method for profiling a graphics application.

FIG. 3 is a diagram of a graphics profiling system.

FIG. 4 is a diagram of a graphics profiling apparatus.

### DESCRIPTION OF THE EMBODIMENTS

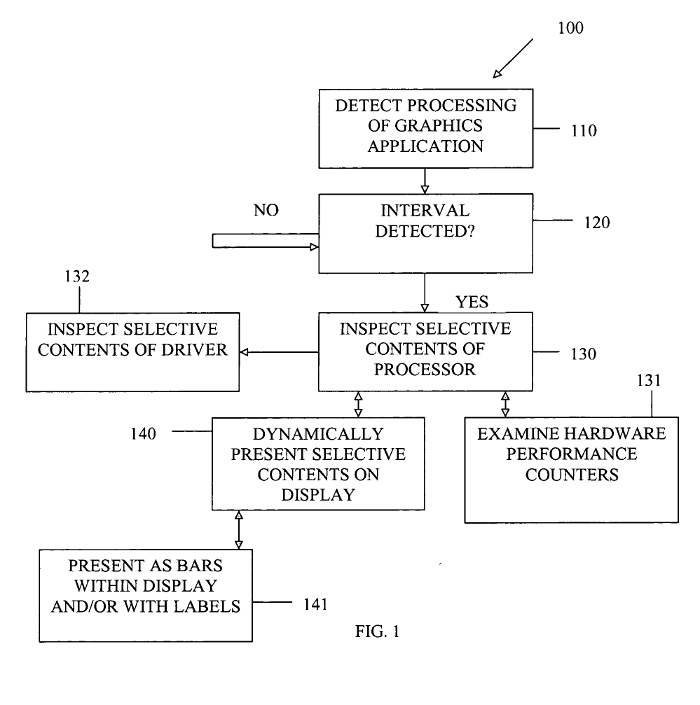

FIG. 1 is a flowchart of one method 100 to profile the processing of a graphics application. The method (hereinafter “profiler”) is implemented in a computer accessible medium. In one embodiment, the profiler is one or more software applications which reside and execute on one or more processors. The processors also execute a graphics application. A graphics application is one or more software applications that produce graphics, image, or video (e.g., video games, animation, imaging, video conferencing, movies, etc.), within and on the processors and are communicated to a display interfaced to the processors. The display can communicate directly with the processors or indirectly over a network, communication between the display and the processors can be hardwired, wireless, or a combination of hardwired and wireless.

The profiler monitors the processing of the graphics application as it executes on the processors. Accordingly, at 110, the profiler detects a graphics application that is executing on the same platform (e.g., same processors, etc.) as the profiler. One technique for detecting an executing graphics application is to receive notice when the graphics application initiates (loads) or to monitor processors and memory for specific activity associated with a graphics application. In some embodiments, the profiler monitors graphics events via Chipset Hardware Architecture Counters (CHAP) and an associated graphics driver interface. When graphics events occur the events can be associated with specific source lines of code (associated with the graphics application) via symbol tables. This extends the features of the profiler and specifically directs a developer, during a monitor session, to specific areas of source code associated with the developer's graphics application. Thus, the profiler can be extended to provide a more interactive and useful analysis tool for developers of graphics applications, by linking graphics events to specific source code areas associated with currently executing graphics applications while the graphics applications are being monitored by the profiler.

The profiler is configured to determine and inspect a graphics processor and memory usages associated with an executing graphics application at predefined intervals. The predefined intervals can be pre-set or predefined to be randomly selected. Thus, the profiler inspects a graphics application usage of a graphics processor and memory at predefined intervals.

The profiler logically performs two functions; the first function is to inspect and gather processor and memory usage statistics (selective contents) associated with an executing graphics application. The second function presents these gathered statistics to a display for inspection by a viewer that desires to profile the processing of the graphics application. The viewer profiles the graphics application for purposes of determining how the code associated with the graphics application can be improved to achieve better processor and memory performance on the specific platform in which the graphics application is executing when the profiler is used to profile it.

In one embodiment, at 130, the profiler, at the predefined intervals, inspects the contents of processor counters which are being used by the graphics application during execution. In some embodiments, at 131, these are the Chipset Architecture Performance (CHAP) Counters that relate to 3D processor engine performance. Inspection of these counters permit the profiler to determine whether zone rendering is enabled, the total number of pixels presently being rendered, the total number of polygons presently being rendered, the performance speed of the graphics memory, etc.

In one embodiment, at 132, the profiler also inspects contents associated with any graphics driver that is being used to interface with the executing graphics application. The graphics driver is an interface for the code of the graphics application to the underlying hardware (e.g., processor and memory) which is needed to translate and process the graphics application code into graphical output data which is ultimately rendered to a display for a viewer.

The profiler dynamically presents the selective contents within a display for a viewer, at 140, when selective contents are acquired from the processor and/or driver counters. Presentation can occur in a variety of configurable manners. The embodiments of the invention are not limited to any particular presentation of the selective contents within the display. In one embodiment, at 141, the presentation depicts labels along with horizontal bars which expand and contract based on activity associated with the selective contents.

For example, in one embodiment, the presentation is a graphical window which includes labels “DDR Speed (Double Data Rate (DDR) Synchronous Dynamic Random Access Memory (SDRAM)),” “Graphics Memory Used,” “Total Pixels Rendered,” “Polys (Polynomials) Entering Rendering,” and “Polys Entering HW (Hardware) Binner.” The labels associated with “DDR Speed” and “Graphics Memory Used” include portions of the selective contents within the presentation which identify the specific memory speed and memory usage in bytes. The remaining labels are associated with a horizontal bar capable of depicting no activity or a maximum activity depending upon the size of the associated bars. The bars grow and shrink based on the selective contents retrieved by the profiler during one of its inspection intervals. An example presentation depicted as a graphical window within a display may appear as follows:

[image]

In other embodiments, the presentation need not use graphical bars and can be displayed as a combination of numeric and textual information. Moreover, the presentation can include useful processing and memory statistics associated with the driver interface and video memory. As one example, consider the following example presentation which the profiler can produce for a developer monitoring the graphics performance of the developer's application:

[image]

The presentation of the selective contents within the display can occur within a sub-window that is overlaid on top of graphical output being concurrently produced by the executing graphics application. The presentation can occur within a window that is separate and distinct from the graphical output of the executing graphics application. Alternatively, the presentation can be presented within the display without any graphical output associated with the executing graphics application. In these latter embodiments, the output for the executing graphics application is produced but is suppressed from being presented on the display, such that only the presentation of the selective contents is presented within the display.

In an example application of the profiler, the graphics application is a video game running on a specific architectural platform having a graphics processor and a graphics driver for interfacing with that graphics processor. A developer of the graphics application is a viewer that either initiates the profiler manually or automatically and indirectly initiates the profiler when the developer initiates his/her graphics application (in this latter scenario, the profiler is linked and initiated from some portions of the graphics application).

The developer is using the profiler to determine problem areas within the graphics application code which create longer processing latency than is desired for the performance of the video game. As the developer executes his/her graphics application, the profiler inspects selective contents of graphics counters associated with activity occurring within the graphics processor and the graphics driver; these selective contents are dynamically presented to the developer as the graphics application executes. When the developer reaches an execution point that indicates excessive load and processing, the developer can inspect the corresponding code to determine how that code can be altered to better process on this particular architectural platform. It may be that the developer needs to delay making a write request, needs to use a different type of data structure, needs more or less caching, needs more or less locking, etc.

The profiler provides techniques for monitoring and profiling hardware and software events associated with graphics processing which have heretofore not been available. This permits vendors to develop customized graphics application code for targeted platform architectures. In turn, this permits vendors to make new graphics applications available to consumers who do not desire to upgrade their platforms but who do desire to purchase a vendor's graphics application. Accordingly, the profiler permits software developers to customize and optimize their graphics applications for specific architectural platforms.

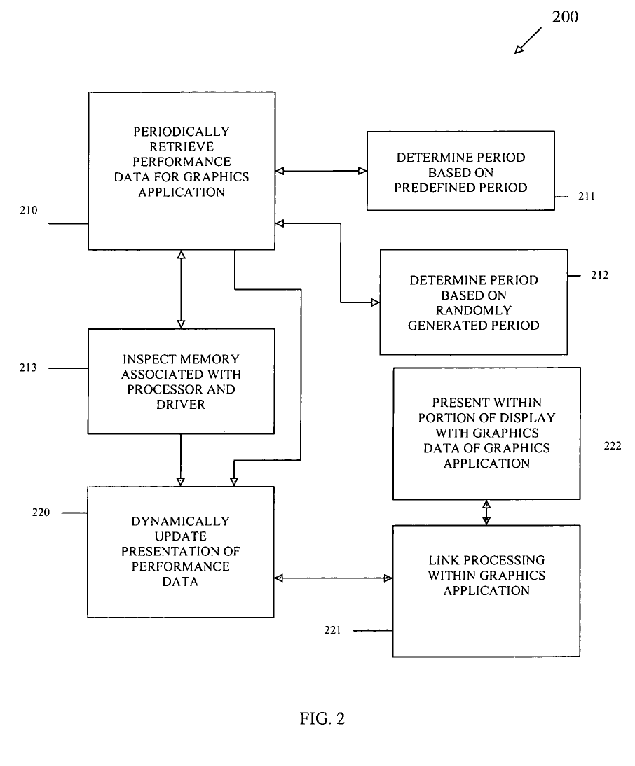

FIG. 2 is a flowchart of another method 200 to profile a graphics application. The method 200 (herein after “profiler”) is implemented in a computer accessible medium. The profiler can be packaged on fixed or removable computer-readable media and distributed for installation and execution within a processing environment. Thus, in one embodiment, the profiler resides on a removable computer readable storage medium and is capable of being interfaced to a desired processing environment, loaded, and executed thereon. In other embodiments, the profiler is distributed to a particular processing architecture via a network connection. In still other embodiments, the profiler is natively available and bundled with a particular processing architecture.

In some embodiments, the profiler is a variety of modules that can execute independently within a processing environment (platform). In other embodiments, the profiler can be embedded, linked, and executed from customized graphics applications. In these latter embodiments, the profiler is packaged as one or more software utilities or library modules which can be referenced and linked from code associated with a graphics application. In this way, a developer of a graphics application can initiate the profiler embodied in FIG. 2 independent of his/her customized graphics application or the developer can integrate the profiler embodied in FIG. 2 into the code associated with his/her customized graphics application.

When the profiler is executing, it monitors performance data associated with the execution of a graphics application. Accordingly, at 210, the profiler periodically retrieves performance data for an executing graphics application. The periodicity is a configurable attribute of the profiler. Thus, in one embodiment, at 211, the period set for retrieving the performance data can be based on a predefined period. In another embodiment, at 212, the period set for retrieving the performance data can be based on a randomly generated period. In still other embodiments, the period can be set based on a detected configurable event which the profiler is designed to detect before retrieving performance data for an executing graphics application.

The performance data includes processor and memory characteristics which the profiler is designed to retrieve from specific counters, register, and memory associated with rendering graphical output for the graphics application. Thus, performance data includes, by way of example only, such things as memory speed, memory usage in bytes, total pixels rendered, polynomials entering rendering, polynomials entering HW (hardware) binner processing, and the like. The performance data can be retrieved at the configured periods by inspecting memory and structures (counters and registers) associated with a graphics processor and graphics driver, as depicted at 213.

Once performance data is retrieved; it is used for dynamically updating, at 220, a presentation of previously displayed performance data on a display. Of course, during a first or initial period of retrieving the performance data the previously displayed performance data will be null. As was discussed above in detail with respect to FIG. 1 and method 100, the presentation of the performance data can occur in a variety of manners within the display of a viewer and the embodiments of the invention are not intended to be limited to any particular presentation within the display.

The performance data is dynamically and continually updated as a presentation within the display as the graphics application executes. This permits a viewer of the presentation to discern when memory or processing becomes loaded down and begins to perform in less than optimal manners (e.g., experiences unacceptable latency, etc.). This profiling information can be used to re-evaluate specific code areas within the graphics application where the memory and processing loads appear to be unacceptable to the viewer. The viewer may then interactively redesign and rewrite those problem code areas and re-execute the modified graphics application with the profiler of FIG. 2 to determine if processor or memory performance is now acceptable.

This technique can be used interactively and repetitively by the viewer (developer) until the viewer has a version of his/her graphics application code that is acceptable for the platform on which the profiling occurred. The profiler of FIG. 2 can then be installed and executed in concert with the graphics application on a different platform for purposes of optimizing another instance of the graphics application code for that different platform.

Conventionally, performance data associated with graphics processors of specific platforms and graphics drivers was not capable of being profiled. As a result, developers could not adequately and efficiently customize their graphics applications for acceptable performance on different targeted processing platform architectures. This limited the target market for the applications and upset many otherwise willing buyers. These problems are solved with the embodiments of this invention.

In some embodiments, at 221, the profiler is linked and integrated into the code of the graphics application, such that when the graphics application accesses a graphics driver the profiler is initiated or called. This permits the profiler to be configured with the graphics application and permits the profiler to be turned on and off through parameters passed to the graphics application when it is initiated (loaded) or initially executed. Thus, a developer can turn the features of the profiler on and off as desired.

In one embodiment, at 222, where the profiler is integrated with the code of a graphics application, the presentation of the performance data can also be configured to display in a customized fashion within the graphical output (graphical data) associated with an executing version of that graphics application. For example, as graphical data and windows are produced on a display with an executing version of the graphics application, the presentation associated with the dynamically updated performance data can be displayed simultaneously in sub windows which overlay some portions of the outputted graphical data. This gives the developer (viewer) a real-time and dynamic view of how the performance data relates to executing portions of his/her graphics application.

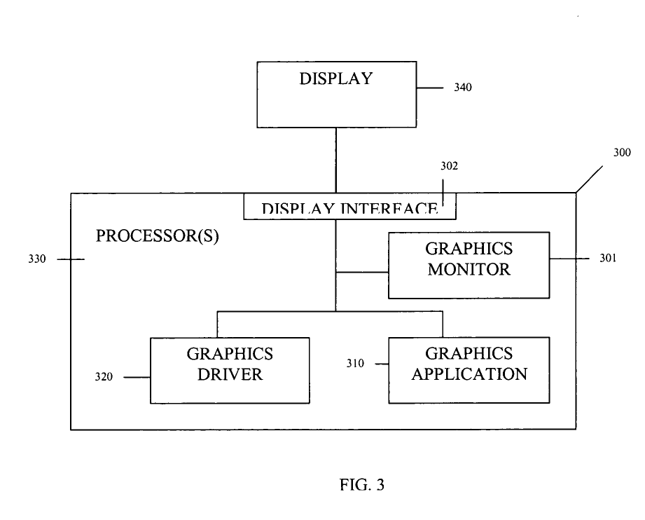

FIG. 3 is a diagram of a graphics application profiling system 300. The graphics application profiling system 300 resides in a computer accessible medium and can be installed and executed in a variety of processing architectures. In one embodiment, the graphics application profiling system 300 implements the processing described above with respect to methods 100 and 200 of FIGS. 1 and 2, respectively.

The graphics application profiling system 300 includes a graphics monitor 301 and a display interface 302. These components are implemented to perform the processing described above with respect to the methods 100 and 200 of FIGS. 1 and 2, respectively. The graphics monitor 301 monitors and retrieves selective contents of a processor associated with performance data (e.g., memory speed, memory usage, pixels rendered, polynomials entering rendering, polynomials entering HW binner, etc.). The performance data is produced by an executing graphics application 310. In some embodiments, the selective contents are also associated with performance data associated with a graphics driver 320 that interfaces with the graphics processor on behalf of the executing graphics application.

The graphics monitor 301 can be configured to inspect the selective counters, registers, and memory for the selective contents at predefined intervals. The predefined intervals can be based on a set number of elapsed processing cycles, a set period of elapsed time, a randomly generated number of processing cycles, or a randomly generated period of elapsed time. In other embodiments, the intervals can be determined based on predefined processing events which the graphics monitor 301 is designed to listen for. The graphics monitor 301 also interfaces with the display interface 302.

The display interface 302 receives the selective contents from the graphics monitor 301 at the defined intervals and updates a presentation associated with the updated selective contents to a display 340. The display 340 is being monitored by a viewer (developer) to ascertain the performance of an executing graphics application 310, which is executing in the processor architecture 330. The presentation of the selective contents within the display 340 vis-à-vis the execution state of the graphics application 310 permits the viewer to identify areas within the code of the graphics application 310 which need to be or may benefit from modification for purposes of improving processor and/or memory performance within the processor architecture 330.

In one embodiment, the selective contents are dynamically updated and presented within in the display 340 via the display interface 302 as a graphical window. In some embodiments, this graphical window overlaps one or more graphical output windows that are dynamically being produced by the executing graphics application 310. The selective contents presentation can be textual, graphical, or a combination of textual and graphical. That is, portions of the selective contents can be presented on the display 340 as text and portions can be presented with visual aids, such as graphical bars, diagrams, charts, and the like. Moreover, in some embodiments when certain thresholds are detected within the values associated with the selective contents audio communications or alarms can be simultaneously communicated to an audio device and communicated to the viewer who now also becomes a listener. The presentation can include customized visual effects (e.g., blinking), customized fonts, customized textures, customized colors, etc.

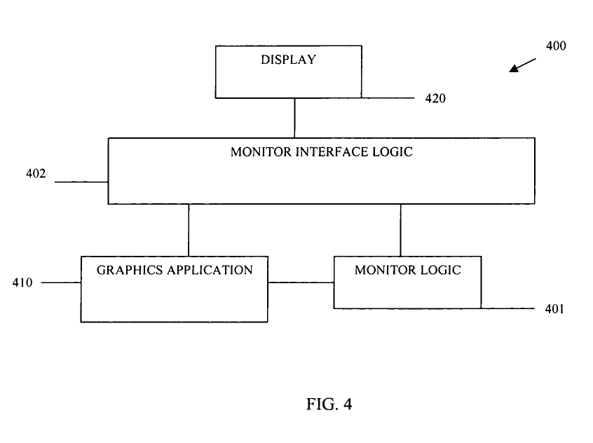

FIG. 4 is a diagram of a graphics application profiler apparatus 400. The profiler apparatus 400 is implemented in a computer accessible medium. In one embodiment, profiler apparatus 400 is installed on removable computer readable medium for distribution, eventual loading, and eventual execution on a processing architecture. In other embodiments, the profiler apparatus 400 is distributed dynamically over a network (e.g., Internet) to a specific target processor architecture where it can be subsequently loaded and executed as desired. In still other embodiments, the profiler apparatus 400 executes as a service on a defined processing architecture and can be remotely accessed and processed in combination with an executing graphics application, which also runs on the defined processing architecture. In yet other embodiments, the profile apparatus is bundled as pre-installed services within existing processor architectures. In one embodiment, the profiler apparatus 400 performs the operations and features described above with respect to methods 100 and 200 and system 300 of FIGS. 1-3 respectively.

The profiler apparatus 400 includes monitor logic 401 and monitor interface logic 402. The monitor logic can be a single software application (module) or a suite of software applications (modules) that are available in software libraries and interact with one another from purposes of monitoring the performance of graphics processors and graphic drivers during the execution of a graphics application within specific processor architectures.

The monitor logic 401 is implemented to acquire specific performance data from predefined hardware and software resources, which are associated with graphics processors and graphics drivers. This performance data is acquired at configurable periods or intervals. The periods can be pre-set to occur at fixed intervals or pre-set to occur at random intervals. The monitor logic 401 acquires the performance data for an executing graphics application 410. As the executing graphics application 410 processes, it contacts the graphics driver and the driver uses the graphics processor to carry out the operations defined in the graphics application code (logic). As these operations are processed, the resources memory, counters, registers will experience a usage load, that usage load is retrieved as the performance data by the monitor logic 401 at the defined periods.

The monitor logic 401 communicates retrieved values associated with the performance data to the monitor interface logic 402. Again, the monitor interface logic 402 can be a single application (module) or a suite of applications (modules) residing in a software library. The monitor interface logic 402 is responsible for presenting the dynamically changing values associated with the performance data to a display 420, which a viewer monitors. The monitor interface logic 402 can be configured to present the values of the performance data in a variety of manners. In some embodiments, presentation can be graphical, textual, and/or audible (in cases where an audio device (speaker) is present). A viewer uses the presentation on the display 420 for profiling and evaluating the processing and memory performance characteristics associated with the code of his/her executing graphics application 410.

In some embodiments, the viewer can interact with the monitor interface logic 402 for purposes of configuring the period or interval associated with the monitor logic 401. The viewer can also interact with the monitor interface logic 402 to suspend or start the processing associated with the monitor logic 401. Additionally, in one embodiment, the features of the monitor logic 401 and the monitor interface logic 402 can be integrated and linked to selective portions of the viewer's graphical application 410. In this way, the profiler apparatus 400 can be a standalone apparatus, or can be an apparatus that is integrated within a customized graphics application 410.

The profiler apparatus 400 permits developers (viewers) to profile instances of their graphics applications on specific processing architectures. This has not been achievable in the past because there has been no ability to monitor the performance and activity of graphics processors during graphics processing; rather, developers have conventionally relied on generically optimizing their graphics application code for generic processing architectures. With embodiments and teachings of this invention, this is no longer the case, because now developers can customize specific instances of their graphics applications for specific processing architectures. Each of these instances can be optimized and evaluated using the embodiments presented herein to analyze and profile the processor performance of a particular targeted processing architecture.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which such claims are entitled.

The Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method, comprising:
detecting the processing of a graphics application;
inspecting selective contents of a processor at intervals during the processing;
dynamically presenting the selective contents to a display at the defined intervals.

2. The method of claim 1 further comprising:
inspecting additional selective contents of a graphics driver at the intervals during the processing; and
dynamically presenting the additional selective contents at the defined intervals.

3. The method of claim 1 wherein inspecting further includes examining hardware performance counters of the processor.

4. The method of claim 1 wherein inspecting further includes acquiring zone rendering information as the selective contents.

5. The method of claim 1 wherein presenting further includes presenting portions of the selective contents as a graphical bar which grows larger as more activity is detected within the processor during the processing and which grows smaller as less activity is detected with the processor during the processing.

6. The method of claim 1 wherein presenting further includes associating and presenting labels with portions of the selective contents within a display window.

7. The method of claim 6 wherein associating and presenting further includes presenting the labels as at least one of a total pixels rendered label, a polynomial entering rendering label, and a polynomial entering a hard ware binner label.

8. A method, comprising:
retrieving performance data associated with a processing graphics application;
dynamically updating a presentation of the retrieved performance data as the graphics application processes.

9. The method of claim 8 wherein retrieving further includes determining a period for retrieving the performance data based on a predefined period.

10. The method of claim 8 wherein periodically retrieving further includes determining a period for retrieving the performance data based on at least one of a randomly generated period and detection of an event.

11. The method of claim 8 wherein periodically retrieving further includes inspecting memory associated with a processor and a graphics driver to retrieve the performance data.

12. The method of claim 11 wherein periodically retrieving further includes retrieving zone rendering information from the memory related to rendering a three-dimensional image.

13. The method of claim 8 further comprising linking portions of the graphics application to the processing of the method.

14. The method of claim 13 further comprising dynamically presenting the presentation within a portion of a display that presents the graphics data of the graphics application.

15. A system, comprising:
a graphics monitor; and
a graphics display interface, wherein the graphics monitor processes while a graphics application processes and inspects selective contents of a processor at intervals, and wherein the selective contents are communicated to the graphics display interface to be dynamically presented at the intervals on a display.

16. The system of claim 15 wherein the graphics monitor also inspects additional selective contents associated with a graphics driver and communicates the additional selective contents to the graphics display interface where they are dynamically and concurrently presented at the intervals on the display with the selective contents.

17. The system of claim 15 wherein the selective contents are related to at least one of zone-rendering information and double-data-rate synchronous dynamic random access memory speed information.

18. The system of claim 15 wherein the graphics display interface presents the selective contents within a graphic window of the display.

19. The system of claim 18 where the graphic window is overlaid on one or more additional windows which are presented as a result of the processing graphics application within the display.

20. A machine accessible medium having associated instructions, which when accessed, results in a machine performing:
monitoring performance data associated with a processing graphics application; and
dynamically updating a presentation of the performance data on a display at periodic intervals.

21. The medium of claim 20 wherein the graphics application is an application related to an electronic game.

22. The medium of claim 20 further including instructions for acquiring the performance data from a processor that is processing the graphics application and from a graphics driver associated with the processing of the graphics application.

23. The medium of claim 20 wherein the performance data is related to zone rendering associated with graphics data that the graphics application is processing.

24. The medium of claim 23 wherein the graphics data is related to one or more three-dimensional objects.

25. An apparatus, comprising:
monitor logic linked to selective portions of a graphics application; and
monitor interface logic interfaced to the monitor logic and to a display associated with the graphics application, wherein during execution of the graphics application the monitor logic is invoked and dynamically inspects selective memory contents associated with a processor and graphics driver and communicates the contents to the monitor interface logic, the monitor interface logic presents the contents within a graphical window of the display.

26. The apparatus of claim 25 wherein the graphic window is concurrently updated and displayed as an overlay to one or more additional graphical windows within the display which present graphical data associated with the processing graphics application.

27. The apparatus of claim 25 wherein the monitor interface logic can suspend or restart the processing of the monitor logic.

28. The apparatus of claim 25 wherein the monitor logic is configured to inspect the selective memory contents during at least one of pre-defined intervals and randomly generated intervals.
